(19) United States
(12) Patent Application Publication
(10) Pub. No.: US 2021/0212299 A1
(43) Pub. Date: Jul. 15, 2021

(54) Incubator for Perch Larvae

(71) Applicant: WiSys Technology Foundation, Inc., Madison, WI (US)

(72) Inventor: Kenneth Ashley Webb, JR., De Pere, WI (US)

(21) Appl. No.: 17/148,819

(22) Filed: Jan. 14, 2021

Related U.S. Application Data
(60) Provisional application No. 62/960,926, filed on Jan. 14, 2020.

(51) Int. Cl. A01K 61/17; A01K 61/60

(52) U.S. Cl. CPC A01K 61/17; A01K 61/60

(57) ABSTRACT

A tray system suitable for use with fish laying eggs in skeins provides a set of cassettes having opposed water-permeable faces that may clamp about the edges of the skeins to prevent them from coiling about themselves while exposing both sides of the skeins to flowing water. A regular form factor of the cassettes allows them to be closely stacked with small water flow gaps between them for high hatching density.

### CROSS REFERENCE TO RELATED APPLICATION

This application claims the benefit of U.S. provisional application 62/960,926 filed Jan. 14, 2020, and hereby incorporated by reference.

### STATEMENT REGARDING FEDERALLY SPONSORED RESEARCH OR DEVELOPMENT

N/A

### BACKGROUND OF THE INVENTION

The present invention relates generally to incubators for hatching fish eggs into larvae, and in particular, to an incubator system for fish eggs that are laid in jelly-like skeins.

Fish hatcheries use incubators to hatch fish eggs in an environment removed from predators and the variations in the natural environment that can increase mortality. A commonly used incubator is the so-called “Heath tray” which provides a set of shallow trays allowing water to sequentially flow downward through the trays, and within each tray upward through a false bottom over the eggs. An example early Heath tray design is shown in U.S. Pat. No. 2,982,246 hereby incorporated by reference.

While Heath trays work well for species such as trout and salmon to permit hatching of many eggs in a compact volume (high hatching density), they are less successful in species such as the yellow perch and Eurasian perch where the eggs are laid embedded in protective skeins or jellylike ribbons. In an incubation tray, these skeins can coil over themselves producing areas of anoxia within the skein and resulting in egg mortalities. Additional mortalities can occur if the egg skeins float to the surface of the tray permitting desiccation of the eggs.

### SUMMARY OF THE INVENTION

The present invention provides a tray system suitable for use with fish laying eggs in skeins while providing good hatching density, promoting good water flow around the eggs, and reducing contact between the eggs and open air. The invention provides a set of cassettes that hold short lengths of skein flattened between opposed vertical meshes that provide exposure on both sides of the skein to upwardly flowing water. The regular form factor of the cassettes allows them to be closely stacked with small water flow gaps between them for high hatching density. The cassettes may be placed in a false bottom tray similar to that used in familiar Heath tray designs to be compatible with existing racks and hatchery layouts. A hanger system allows the cassettes to be removed and transferred to a larger tank prior to hatching.

More specifically, the invention provides an incubator for fish eggs skeins having a water-resistant cassette with a first and second frame each presenting a water permeable face. The first and second frames are adapted to move between an open state in which a fish egg skein may be uncoiled and placed between the first and second frame, and a closed state where the first and second frames flank the fish egg skein to resist coiling of the fish egg skein by the proximity of the water permeable faces of the first and second frames on either side of the fish egg skein. A clamp releasably holds the first and second portions in the second state.

It is thus a feature of at least one embodiment of the invention to provide a system for holding egg skeins in an uncoiled state exposed to water while allowing practical incubation density.

The water permeable faces may provide a lattice of water-resistant struts defining lattice openings having an area of at least one square centimeter.

It is thus a feature of at least one embodiment of the invention to minimize obstruction of the egg skein by the structure of the cassette consistent with the small-scale mechanics of the egg skein. It is another object of the invention to permit the cassette to be used during the hatching process allowing escape of the fish larva without undue interference from skein material trapped by the cassette.

In one embodiment, the water permeable face of the first frame may provide a peripheral border around a central opening comprising at least 50% of an area of the water-permeable face.

It is thus a feature of at least one embodiment of the invention to allow preferential clamping of the edges of the skein to reduce interference between the cassette structure and the water flowing around the skein.

In this case, the second frame may provide a lattice structure aligned with the central opening when the first and second frames are in the closed state.

It is thus a feature of at least one embodiment of the invention to provide a support resisting movement of the egg skein outside of the cassette when there is lateral waterflow through the trays. The cassettes may be oriented with respect to any such flow with the second frame downstream.

The water-permeable faces of the first and second frame in the closed state may be spaced apart by a gap of least one-half millimeter and provide protruding nubs extending into the gap to engage the fish egg skein.

It is thus a feature of at least one embodiment of the invention to separate the egg skein from contact over any substantial area with the cassette such as may reduce oxygen flow by using the nubs to provide extremely localized spacing.

The first and second frames maybe joined at one edge by a hinge to pivot respectively by rotation of the hinge between the open state and closed state.

It is thus a feature of at least one embodiment of the invention to simplify installation of egg skeins into the cassette retaining and stabilizing the cassette frames with the hinge allowing only a single angular degree of freedom.

The cassette may haves a neutral or negative buoyancy and in some embodiments may have a center of buoyancy urging the water-permeable faces into a vertical orientation in water.

It is thus a feature of at least one embodiment of the invention to promote submersion of the cassettes in the proper orientation in the event that they become loose from the frames or after a transfer from the trays into open tanks when they are unconstrained by the frames.

The incubator may further include a receiving tray having guides for slidably receiving opposed edges of multiple of the cassettes in the closed state with the water-permeable faces vertically oriented and the cassettes spaced apart parallel to each other for waterflow therebetween.

It is thus a feature of at least one embodiment of the invention to promote an extremely high density of egg skeins for reduced cost and resource usage.

The tray may provide an inlet receiving downwardly flowing water at one and discharging that water beneath the multiple cassettes for upward flow therebetween and may provide an outlet for receiving water after it flows between the cassettes to discharge that water to the inlet of a second tray positioned beneath the tray.

It is thus a feature of at least one embodiment of the invention to provide a stackable system for decreased space usage.

The second tray (and each tray in a stack) may be substantially identical to the first tray.

It is thus a feature of at least one embodiment of the invention to provide a low-cost and simple manufacture and stocking of the trays.

The incubator may further include a hanger providing a hook for pivotally attaching the hanger to a supporting structure, the hanger releasably attachable to the cassette to suspend the cassette with the water-permeable faces substantially vertical beneath the hook.

It is thus a feature of at least one embodiment of the invention to allow the cassettes to be transferred to an open tank during hatching.

These particular objects and advantages may apply to only some embodiments falling within the claims and thus do not define the scope of the invention.

### BRIEF DESCRIPTION OF THE DRAWINGS

FIG. 1 is an exploded perspective view of a fish incubator constructed according to the present invention showing two example cassettes, one inserted into and one removed from a carrier providing an open bottom, the carrier fitting into an incubator container promoting the flow of water upward through the cassettes during the incubation process;

FIG. 2 a perspective view of a cassette of FIG. 1 in an open position for receiving an egg skein between closable open lattice surfaces;

FIG. 3 is in an enlarged perspective view of the lattice surface showing retaining nubs for holding the skein in an extended and planar configuration;

FIG. 4 is a fragmentary cross-section through the cassette of FIG. 1 along line 4-4 of FIG. 1 showing the operation of the nubs of FIG. 3 to retain the skein material without harming the eggs; and

FIG. 5 is a hanger system that may be attached to the cassettes for moving the cassettes into a larger hatching tank close to the time of hatching.

### DETAILED DESCRIPTION OF THE PREFERRED EMBODIMENT

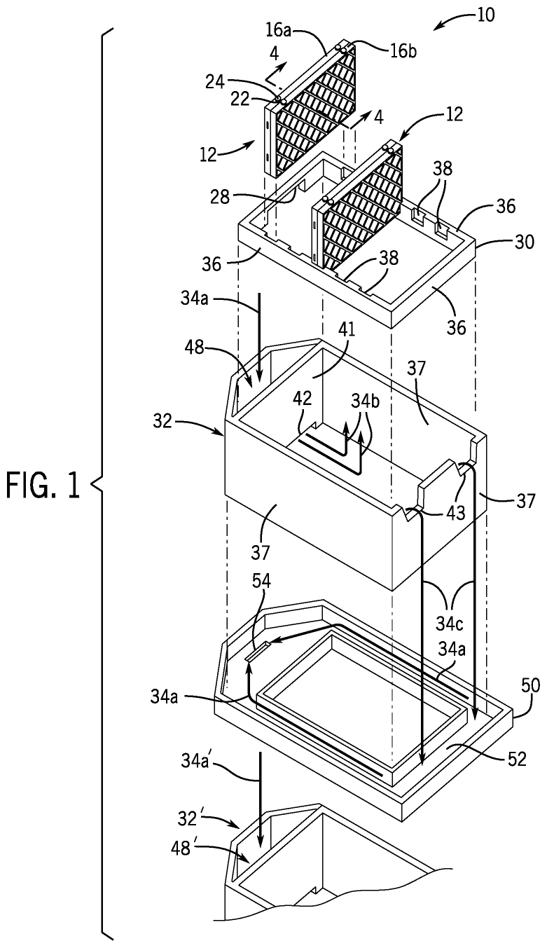

Referring now to FIG. 1, a fish incubator system 10 of the present invention may provide for a set of cassettes 12, the latter, for example, providing in a closed state a generally rectangular periphery 14 formed from parallel front and rear upstanding frames 16a and 16b presenting opposed water-permeable surfaces 17. In exemplary but nonlimiting dimensions, the cassette may be 30 cm along its longest horizontal dimension, 10 cm along its vertical dimension, and 2 cm along a horizontal dimension perpendicular to the other dimensions. The area of the water-permeable surfaces defined by the periphery 14 may be in excess of 200 cm².

Generally, the water-permeable surfaces 17 provide a lattice or mesh structure sized to provide regularly spaced openings, for example, having an area in excess of 1 cm², to provide good water flow through the frames 16 and to allow escape of larva when the cassettes 12 are transferred to a hatching tank to be described. In one embodiment, shown in FIG. 3, the lattice structure may comprise a set of struts 27 defining a rectangular grid, for example, tipped at 45° to the long axis of the cassettes 12.

While both of the frames 16 may have identical structures, in one embodiment frame 16a provides a central opening 25 preferably at least 50% of the area of the front surface 17 that is surrounded by a border 29 of lattice structure. In this case, the border 29 operating with the surface 17 of the opposed frame 16b may clamp the edges of the skein 18 while the opening 25 provides unobstructed access to water. Both frames 16 may have an opening 25 but preferably frame 16b has a lattice structure with smaller openings over its entire surface to provide a backstop against distortion of the skein 18 under a slight horizontal flow of water expected during operation as will be discussed.

Desirably the cassette 12 may have a density that provides neutral or negative buoyancy in water, for example, through the use of a thermoplastic material having sufficient density or molded around weighting material or incorporating a weighted filler. The weighting of the cassette 12 may be distributed, for example, by increased weighting toward a bottom edge, so that when the cassette 12 is immersed in water it tends to orient itself with the water permeable surfaces 17 oriented vertically.

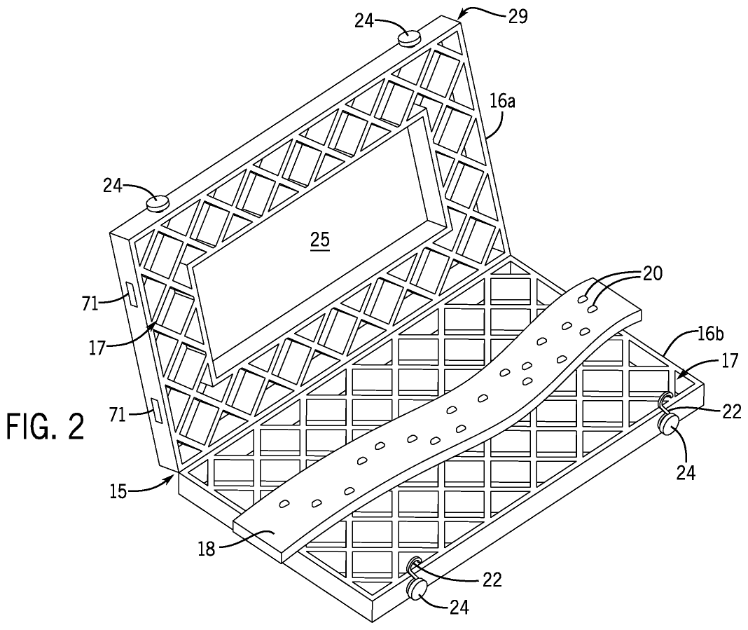

Referring also to FIG. 2, as noted, the cassette 12 is separable into two frames 16a and 16b dividing the cassette 12 shown in FIG. 1 along a vertical plane. The frames 16a and 16b may be joined along the lower edge by a hinge 15 (for example, a living hinge) having a transverse hinging axis allowing the frames 16a and 16b to pivot to receive a length of a skein 18 of fish eggs 20 uncoiled to a generally flat and planar state. After insertion of the skein 18 in between the frames 16, the frames 16a and 16b may be closed together and retained in the closed position by a latch provided by studs 24 projecting from the upper edges of the frames 16 and releasably retained together by an S-hook 22 joining the studs 24. It will be appreciated that a wide variety of other types of fastening systems may be used including snaps or separate clamps, or molded detent features that provide secure but releasable interconnection of the frames 16. The length of the skein 18 may be cut so that the skein 18 is substantially fully surrounded and protected by the frames 16.

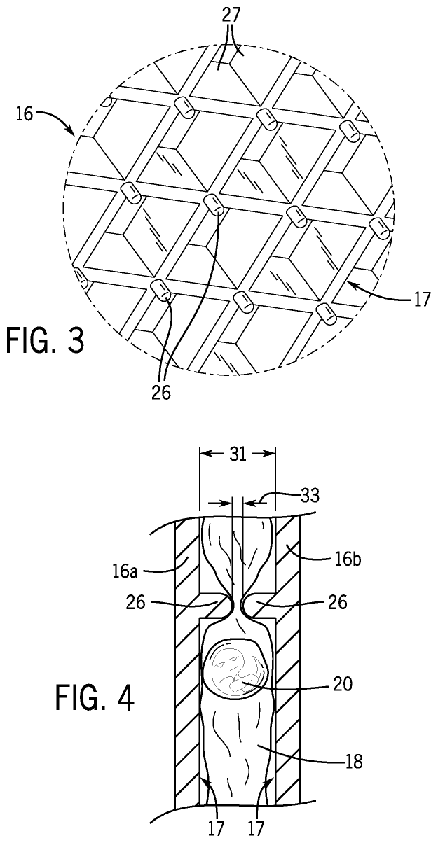

Referring now to FIG. 3 and FIG. 4, the inner surfaces 17 of the frames 16 may provide horizontally and inwardly extending flexible or rigid nubs 26, for example, being generally cylindrical projections with a diameter of 2 mm or less. In one embodiment, the nubs 26 may extend inward by about 0.25 mm, for example, from points of intersection of the material of the frames 16 when the frames 16 provide a network of crossing rectilinear struts 27. The nubs 26 and the struts 27 of the frames 16 may have rounded outer surfaces to avoid sharp edges that could abrade the skein or eggs and serve to space the skeins 18 away from the struts 27 for better water flow.

When the cassette 12 is closed with the frames 16a and 16b closely adjacent and latched, the inner surfaces 17 will be separated by a gap 31 of approximately 1 mm, a dimension being close to but slightly larger than the diameter of an egg 20. Nubs 26 on opposite frames 16a and 16b will align and closely approach each other with a gap 33 of approximately 600 μm to firmly retain the skein 18 and prevent it from contracting and coiling in upon itself. The size and shape of the nubs 26 operates in conjunction with the firmness of the eggs 20 and the dynamic qualities of the skein 18 to allow the eggs 20 to move away from the nubs 26 when the frames 16a and 16b are closed.

Referring again to FIG. 1, multiple cassettes 12 as described may be horizontally arrayed in a carrier 30, the latter being an upwardly open tray of generally rectangular form having an open bottom wall allowing free upward flow 34b of water therethrough. The open bottom wall is surrounded by four upstanding sidewalls 36 joined along their vertical edges.

Flanking sidewalls 36 of the carrier 30, across the width of the carrier 30, may provide for internally extending, mutually opposed pockets 38 to receive, align, and retain the cassettes 12 just above the bottom edge of the carrier 30 to allow water to flow beneath the cassettes. One end of the carrier 30 provides an opening 28 through which water can enter for that purpose.

The width of the carrier 30 is sized to receive the 20 cm long longest dimension of the cassettes 12 and the length of the carrier is such as to allow multiple cassettes 12 to be inserted in parallel, spaced apart fashion with sufficient space between the cassettes 12 (for example, 1 to 2 cm) to allow the free flow of water therebetween.

The carrier 30 may fit within a generally rectangular tank 32 size to allow full submersion of cassettes 12 held in the carrier 30. The height of sidewalls 37 of the tank 32 are sized to allow complete submersion of the cassettes 12 when the carrier 30 is placed at the bottom of the tank 32 and the tank 32 filled with water, a dimension being slightly greater than the 10 cm height of the cassettes 12. A divider wall 41 of the tank 32 is adjacent to the opening 28 of the carrier 30 and provides a corresponding opening 42 aligned with opening 28. The opening 28 leads to a water-receiving compartment 48 forming one end of the tank 32. The water-receiving compartment 48 is open at the top to receive water flow 34a that may then pass through opening 42 in the divider wall 41, through opening 28 of the carrier 30, and upward through the cassettes 12. After passing upward through the cassettes 12, the water may then flow out of cutouts 43 in the wall 37 opposite wall 41. The height of the cutouts 43 is such as to encourage a circuitous path of the water flow 34b upward through the cassettes 12.

The tank 32 may be received by a tray 50 providing a surrounding trough 52 that may receive water flow 34c passing downward from the cutouts 43. This water flow 34d may then be conducted around the trough 52 to the opposite side of the tray 50 to exit through a drain port 54 that can be aligned with the water-receiving compartment 48′ of a tank 32′ identical to tank 32 described above, allowing identical multiple tanks 32 and trays 50 to be assembled in a stack with water pumped into the water-receiving compartment 48 of the uppermost tank 32 and extracted from the lowermost tray 50 to be recirculated. For this purpose, the tray 50 may provide for features allowing it to engage and nest with the upper edge of a lower tank 32.

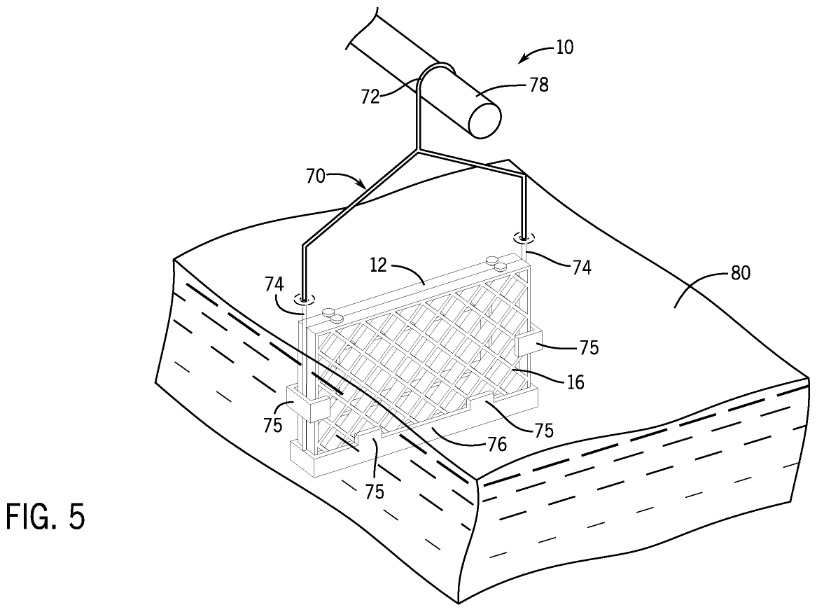

Referring now to FIG. 5, prior to hatching or contemporaneously therewith, the cassettes 12 may be removed from the carrier 30 and the tank 32 and attached to a hanger 70 having an upwardly extending hook 72 in the manner of a clothes hanger and extending downward in two vertical and transversely separated bars 74 along the left and right ends of the cassette 12 when the cassette 12 is in vertical orientation. Retention flanges 75 may extend inward from the bars 74 along the front and rear frames 16 of the cassette to stabilize it in this orientation, and the hanger 70 may provide a lower weighted support passing horizontally on the underside of the cassette 12 to ensure submerging of the cassette when the hanger 70 is suspended, for example, on a longitudinally extending rod 78 above water 80 of a hatching tank. Alternatively, attachment features 71 between the cassette 12 and the hanger 70 may be molded into the cassette 12 to attach it to the hanger 70 as shown in FIG. 2. Gentle agitation of the hanger 70 grasped by the hook 72 above the surface of the water may help to free the hatching larva from the matrix of the skein.

Each of the above described components may be molded of a nonreactive thermoplastic for rust resistance and easy cleaning and sterilization.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What I claim is:

1. An incubator for fish eggs skeins comprising:
a water-resistant cassette having a first and second frame each presenting a water-permeable face, the first and second frames adapted to move between an open state, in which a fish egg skein may be uncoiled and placed between the first and second frame, and a closed state, where the first and second frames flank the fish egg skein to resist coiling of the fish egg skein by proximity of the water-permeable faces of the first and second frames on either side of the fish egg skein; and
a clamp releasably holding the first and second portions in the second state.

2. The incubator of claim 1 wherein the water-permeable faces provide a lattice of water-resistant struts defining lattice openings having an area of at least one square centimeter.

3. The incubator of claim 1 wherein the water-permeable face of the first frame provides a peripheral border around a central opening comprising at least 50% of an area of the water-permeable face.

4. The incubator of claim 3 wherein the second frame provides a lattice structure aligned with the central opening when the first and second frames are in the closed state.

5. The incubator of claim 1 wherein at least one of the water-permeable faces of the first and second frame in the closed state are spaced apart by a gap of least one-half millimeter and provide protruding nubs extending into the gap to engage the fish egg skein.

6. The incubator of claim 1 wherein the first and second frames are joined at one edge by a hinge to pivot respectively by rotation of the hinge between the open state and closed state.

7. The incubator of claim 1 wherein the cassette has a neutral or negative buoyancy.

8. The incubator of claim 7 wherein the cassette has a center of buoyancy urging the water-permeable faces into a vertical orientation in water.

9. The incubator of claim 1 further including a receiving tray having guides for slidably receiving opposed edges of multiple of the cassettes in the closed state with the water-permeable faces vertically oriented and the multiple cassettes spaced apart parallel to each other for waterflow therebetween.

10. The incubator of claim 9 wherein the tray provides an inlet receiving downwardly flowing water at one end to discharge that water beneath the multiple cassettes for upward flow therebetween and wherein the tray provides an outlet for receiving water after flow between the multiple cassettes to discharge that water to the inlet of a second tray positioned beneath the tray.

11. The incubator of claim 10 wherein the second tray is substantially identical to the first tray.

12. The incubator of claim 1 wherein the area of the water-permeable faces is at least 200 cm².

13. The incubator of claim 1 further including a hanger providing a hook for pivotally attaching the hanger to a supporting structure, the hanger releasably attachable to the cassette to suspend the cassette with the water permeable faces substantially vertical beneath the hook.

14. The incubator of claim 1 wherein the cassette is a polymer material.
